(19) United States
(12) Patent Application Publication
(10) Pub. No.: US 2025/0253077 A1
(43) Pub. Date: Aug. 7, 2025

(54) HIGH RESISTANCE SYSTEM GROUNDING USING FLUID AS CONDUCTOR

(71) Applicant: OneSubsea IP UK Limited, London (GB)

(72) Inventor: Audun Magne Askeland, Sandsli (NO)

(21) Appl. No.: 19/046,681

(22) Filed: Feb. 6, 2025

Related U.S. Application Data
(60) Provisional application No. 63/550,433, filed on Feb. 6, 2024.

(51) Int. Cl. H01C 11/00; H01C 1/08

(52) U.S. Cl. CPC H01C 11/00; H01C 1/08

(57) ABSTRACT

A system includes a subsea transformer disposed in a subsea transformer tank, and a subsea high resistance grounding (HRG) system coupled to the subsea transformer. The subsea HRG system includes a subsea high resistance grounding (HRG) tank, a first conductor, a second conductor, and a resistor fluid path in the subsea HRG tank between the first and second conductors. The subsea HRG system also includes one or more insulators in the subsea HRG tank defining the resistor fluid path between the first and second conductors.

### CROSS-REFERENCE TO RELATED APPLICATION

This application claims benefit of U.S. Provisional Patent Application No. 63/550,433, filed on Feb. 6, 2024, which is hereby incorporated by reference in its entirety for all purposes.

### BACKGROUND

The present disclosure relates generally to a high resistance grounding system using fluid as a conductor.

In the subsea oil and gas industry, it is often desirable to perform certain fluid processing activities on the sea floor. Examples include fluid pumps (both single phase and multiphase) and compressors (both gas compressors and “wet gas” compressors). The subsea pumps and compressors are commonly driven with electric motors, which are supplied by three-phase electrical power via one or more umbilical cables from a surface facility. Especially in cases where the umbilical cable is relatively long, it is desirable to transmit the electrical power at higher voltages through the umbilical cable and use a subsea transformer to step-down a voltage suitable for use by the subsea electric motors.

High resistance grounding (HRG) is a principle that is well known and has been used in medium voltage distribution transformer systems. The purpose of the HRG is two-fold: (1) to clamp the otherwise isolated neutral conductor of the transformer to ground; and (2) limit possible ground fault current to a low and well-defined level. In normal operation, the vector sum of the capacitive currents between the three live symmetrical phases will be zero, and no current will flow in the HRG from the transformer neutral conductor. With an earth fault present in one of the phases, the two healthy phases will have the correct line voltage values relative to each other both in magnitude and in phase, although they will be shifted in voltage towards ground.

For subsea transformers connected to high voltage systems (e.g., 66 kilovolt (kV)), there is a need for a high resistance neutral connection, which may be placed subsea. Systems known in the art use seawater as a conducting element at 6.6 kV, but this is not suitable for higher voltages as conduction is too high. While freshwater used as a cooling fluid mixture may mitigate this problem, it also prevents exchange of the fluid and efficient cooling. As such, new techniques are desirable to match desired overall resistance between the conductors (poles) and at the same time ensure sufficient low amperage per cross sectional are to avoid negative effects such as corrosion.

### BRIEF DESCRIPTION

A summary of certain embodiments described herein is set forth below. It should be noted that these aspects are presented merely to provide the reader with a brief summary of these certain embodiments and that these aspects are not intended to limit the scope of this disclosure.

In certain embodiments, a system includes a subsea transformer disposed in a subsea transformer tank, and a subsea high resistance grounding (HRG) system coupled to the subsea transformer. The subsea HRG system includes a subsea high resistance grounding (HRG) tank, a first conductor, a second conductor, and a resistor fluid path in the subsea HRG tank between the first and second conductors. The subsea HRG system also includes one or more insulators in the subsea HRG tank defining the resistor fluid path between the first and second conductors.

In certain embodiments, a method includes operating a subsea transformer disposed in a subsea transformer tank, and grounding the subsea transformer via a resistor fluid path of a subsea high resistance grounding (HRG) system coupled to the subsea transformer. The subsea HRG system includes a subsea high resistance grounding (HRG) tank, a first conductor, a second conductor, and the resistor fluid path in the subsea HRG tank between the first and second conductors. The subsea HRG system also includes one or more insulators in the subsea HRG tank defining the resistor fluid path between the first and second conductors.

In certain embodiments, a system includes a high resistance grounding (HRG) system. The HRG system includes a high resistance grounding (HRG) tank, a first conductor, a second conductor, and a resistor fluid path in the HRG tank between the first and second conductors. The HRG system also includes one or more insulators in the HRG tank defining the resistor fluid path between the first and second conductors.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagram illustrating an embodiment of a subsea system having a subsea transformer using an HRG system;

FIG. 2 is a cut-away diagram of an embodiment of the subsea transformer having the HRG system of FIG. 1;

FIG. 3 is a schematic diagram of an embodiment of the subsea transformer having the HRG system of FIGS. 1 and 2;

FIG. 4 is a schematic diagram of an embodiment of the HRG system of FIGS. 1-3, further illustrating a HRG tank having a fluid-based resistor system and a cooling system;

FIG. 5 is a schematic diagram of an embodiment of the HRG system of FIGS. 1-4, further illustrating an embodiment of the fluid-based resistor system having a winding fluid path defined by a nested arrangement of cup-shaped insulators;

FIG. 6 is a schematic diagram of an embodiment of the HRG system of FIGS. 1-4, further illustrating an embodiment of the fluid-based resistor system having a winding fluid path defined by a nested arrangement of annular insulators;

FIG. 7 is a schematic diagram of an embodiment of the HRG system of FIGS. 1-4, further illustrating an embodiment of the fluid-based resistor system having a winding fluid path defined by a staggered arrangement of projecting insulators;

FIG. 8 is a schematic diagram of an embodiment of the HRG system of FIGS. 1-4, further illustrating an embodiment of the fluid-based resistor system having a winding fluid path (e.g., spiral fluid path) defined by a spiraling insulator;

FIG. 9 is a schematic diagram of an embodiment of the HRG system of FIGS. 1-4, further illustrating an embodiment of the fluid-based resistor system having a straight fluid path and a pressure compensator.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components. Certain terms are used throughout the description and claims to refer to particular features or components. As one skilled in the art will appreciate, different persons may refer to the same feature or component by different names. This document does not intend to distinguish between components or features that differ in name, but not function.

The present disclosure relates to embodiments of a subsea transformer having a high resistance grounding (HRG) system. According to some embodiments a fluid based HRG system is described. Using fluid as a resistive medium has several advantages over solid-based high resistance ground techniques that have been used in subsea applications. Cooling may be more effective when using freshwater as the resistive medium. A freshwater based HRG system may also be very reliable, which is often an important consideration in subsea applications where intervention costs are relatively high.

As the subsea transformer having an HRG system does not require continuous operation, the fluid does not need to flow through the device. Thus, the HRG system may use freshwater with or without chemical inhibitors and may not require any change out of the water. The system may include an enclosed HRG tank, where an outer wall also includes one of the conductors. The enclosed HRG tank may be any suitable shape and geometry that may be pressurized including, but not limited to, circular, cylindrical, oblong, rectangular, etc. The passage length from one conductor to the other may be adjusted by making a labyrinth of electrically insulative material. This labyrinth can either be axial, radial, or a combination of both. The inner conductor may be at a high potential (i.e., high voltage) and the outer conductor may be at a ground potential.

Preliminary simulations indicate resistance and current density in the fluid and electrical field strength in the insulator. Water has a thermal capacity of 4184 joules/kilograms kelvin (J/kg·K) (at 20° Celsius). A 66 kV system with 20 ampere (A) HRG has a 762-kilowatt (kW) loss but with only 0.5 seconds of operation, this relates to 381 kilojoules, so 10 kg of water would only increase 9 K. The proposed geometry has much larger liquid volume. Depending on the volume and construction of the selected geometry, a volume compensation mechanism may be included to allow for thermal volumetric expansion. Any suitable volume compensation mechanism known in the art may be used.

While the disclosed embodiments are described as including freshwater as the conductor in the HRG system, any conductive fluid may be used including, but not limited to, freshwater, cooling fluid or any other fluid with suitable conductivity. Freshwater is suitable as a conductor but may be problematic during transport as it can freeze to ice. A more suitable fluid may therefore be a cooling fluid, such as those used for general cooling systems in the automotive industry. There is a wide range of fluids to select from with a broad range of conductivity, which means a suitable solution with fluid and geometry may be found to optimize size and complexity. As for prior art systems, when there is no fluid in the resistor, high voltage testing can be performed on the transformer because neutral is isolated from ground, which is a benefit during assembly and testing. The fluid solution is a much cheaper and simpler solution than a solution with metallic or ceramic resistive elements, for example. This is due to the inherent high resistance and thermal capacity of the fluid.

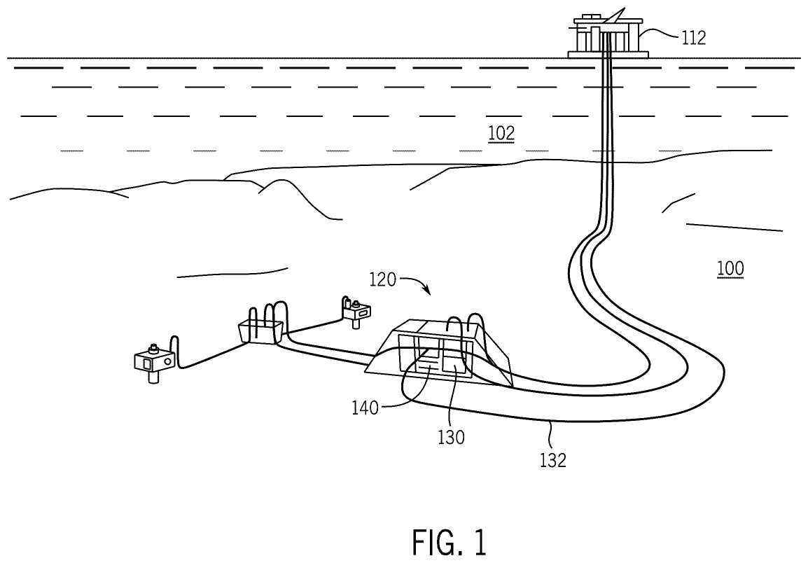

FIG. 1 is a diagram of an embodiment of a subsea system 10 including a subsea transformer 140 (e.g., step-down transformer) having a fluid-based HRG system 220. As discussed in detail below, the HRS system 220 includes fluid as a conductor for high resistance grounding, for example, by defining one or more fluid paths within the subsea transformer 140. On a sea floor 100, a station 120 is shown which is downstream of several wellheads being used, for example, to produce hydrocarbon-bearing fluid from a subterranean rock formation. Station 120 includes a subsea pump module 130, which has a pump (or compressor) that is driven by an electric motor. The station 120 is connected to one or more umbilical cables, such as umbilical 132. The umbilicals in this case are being run from a platform 112 through seawater 102, along sea floor 100 and to station 120. In other cases, the umbilicals may be run from some other surface facility such as a floating production, storage and offloading unit (FPSO), or a shore-based facility. In many cases to reduce energy losses, it is desirable to transmit energy through the umbilicals at higher voltages than is used by the electric motor in pump module 130. Station 120 thus also includes the subsea transformer 140, which converts the higher-voltage three-phase power being transmitted over the umbilical 132 to lower-voltage three-phase power for use by pump module 130. In addition to pump module 130 and transformer 140, the station 120 can include various other types of subsea equipment, including other pumps, compressors, valves, sensors, and controllers. The umbilical 132 can also be used to supply barrier and other fluids, and control and data lines for use with the subsea equipment in station 120. Note that although transformer 140 is referred to herein as a three-phase step-down transformer, the techniques described herein are equally applicable to other types of subsea transformers, such as having other numbers of phases, and being of other types (e.g., step-up transformer).

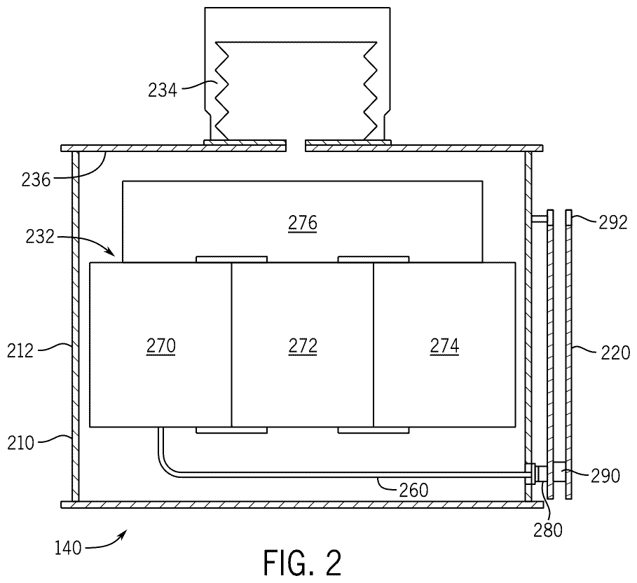

FIG. 2 is a cut-away diagram showing various components of the subsea transformer 140 employing the HRG system 220 of FIG. 1, according to some embodiments. The subsea transformer 140 includes a transformer tank 210 coupled to and/or including the HRG system 220. Inside the transformer tank 210 is an active portion 232 of the transformer 140, which includes the primary and secondary windings 270, 272 and 274 for the three phases as well as the transformer core 276. A transformer tank compensator 234 is used to compensate the transformer tank 210 volume for pressure changes due to temperature fluctuations. The active portion 232 is sealed in the transformer tank 210 by a transformer tank 212 and a tank lid 236. According to some embodiments, the subsea transformer 140 is a two-tank design using double barriers.

Also visible in FIG. 2 is neutral conductor 260 that is directly connected to the neutral node of the secondary windings for the three phases (i.e., which are arranged in a “wye” configuration). The neutral conductor 260 exits the transformer tank 210 via a bushing 280 and makes a connection to an electrode 290 of the HRG system 220. On the upper end of HRG system 220 is an upper electrode 292 that is electrically connected to ground, which in this case is the transformer tank 210. According to some embodiments, the transformer tank walls 212 are grounded, and are grounded through connection to an umbilical termination head (not shown), and up to the vessel or surface facility, such as platform 112 shown in FIG. 1.

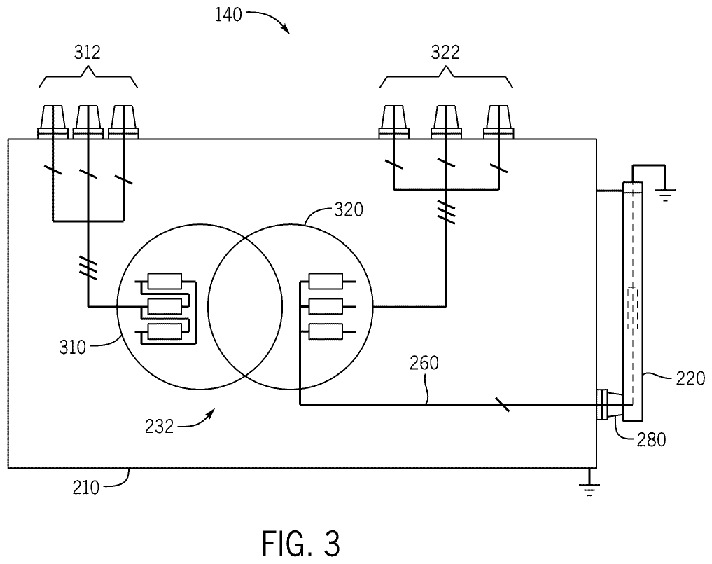

FIG. 3 is a schematic diagram showing further aspects of the subsea transformer 140 employing HRG system 220, according to some embodiments. In this diagram, it can be seen that the active portion 232 of the subsea transformer 140 is arranged in a “delta” structure for the primary windings 310 and a “wye” structure for secondary windings 320. Also visible are primary phase bushings 312 and secondary phase bushings 322. The neutral conductor 260 is shown running from the neutral node of the secondary windings 320 through bushing 280 to the HRG system 220.

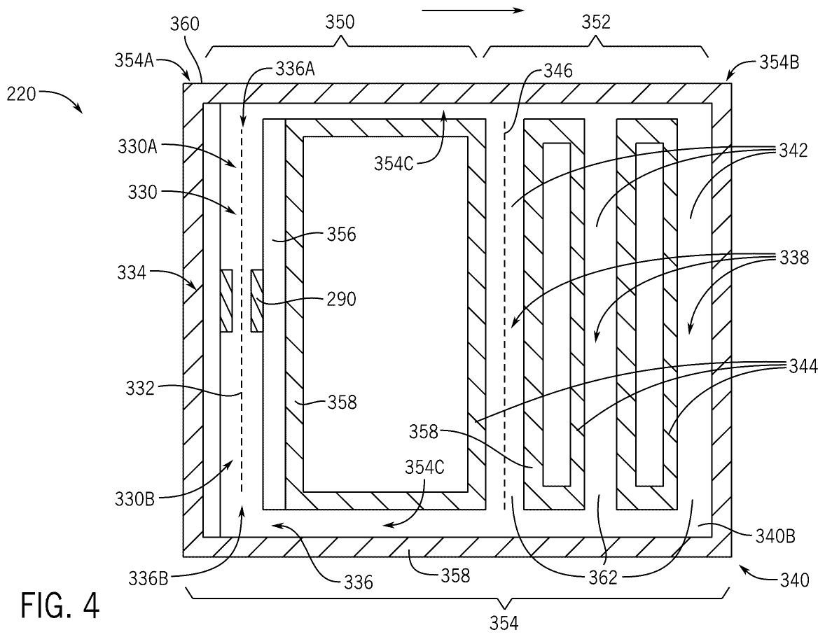

FIG. 4 is a schematic diagram of an embodiment of the HRG system 220 of FIGS. 1-3, further illustrating details of the HRG system 220 including a resistor system 350 (e.g., fluid resistor section) and cooler pipes 352 (e.g., fluid cooling section). The resistor system 350 and cooler pipes 352 may be housed within a HRG tank 354 having HRG tank walls 360. In certain embodiments, the resistor system 350 and the cooler pipes 352 are disposed in separate HRG tank portions 354A and 354B, which are mechanically and fluidly coupled together via HRG tank portions 354C (e.g., connecting fluid passages). The HRG tank 354 (e.g., HRG tank walls 360) may be constructed of any suitable metal having suitable electrical conductivity, thermal conductivity, and corrosion resistance. For example, the HRG tank 354 may be constructed of stainless steel, aluminum, titanium, brass, bronze, and various alloys, and the HRG tank 354 may include corrosion resistant coatings and/or surface treatments along interior and/or exterior surfaces. The HRG tank 354 is constructed for subsea operations, and thus the HRG tank 354 is externally surrounded by seawater. In certain embodiments, the seawater externally surrounds the HRG tank portion 354A having the resistor system 350, the HRG tank portion 354B having the cooler pipes 325, and the HRG tank portion 354C extending between the HRG tank portions 354A and 354B. The HRG tank walls 360 and the rest of the HRG tank 354 may be composed of the same metal. In other embodiments, the HRG tank walls 360 may be resistant to corrosion by seawater but not conductive, while the rest of the HRG tank 354 is conductive but not resistant to corrosion by seawater. In still other embodiments, the HRG tank walls 360 and the rest of the HRG tank 354 may be constructed of two separate, conductive, corrosion-resistant metals. This may be more cost effective, based on the selected metals.

The resistor system 350 within the HRG tank 354 may include one or more insulators 356 (e.g., electrical insulators) along the HRG tank walls 360, one or more ground conductors 358 in the HRG tank walls 360, and one or more neutral conductors 290 along the insulators 356. In the illustrated embodiment, the resistor system 350 includes a resistor fluid path 330 (e.g., resistive fluid circuit) defined by (or bounded by) the one or more insulators 356. The resistor fluid path 330 extends along a longitudinal axis 332 from the neutral conductors 290 to the ground conductors 358. The insulators 356 separate the neutral conductors 290 and the fluid 362 from the ground conductors 358 along the longitudinal axis 332 of the resistor fluid path 330. In the illustrated embodiment, the neutral conductors 290 are disposed at an intermediate position 334 (e.g., centered position) between opposite ends 336 (e.g., 336A and 336B) of the resistor fluid path 330, thereby defining opposite resistor fluid paths 330A and 330B extending from the neutral conductors 290 to the opposite ends 336 (e.g., 336A and 336B). The illustrated resistor fluid path 330 is generally straight or linear along the longitudinal axis 332. In some embodiments, the resistor fluid path 330 may include one or more straight or linear paths, curved paths, winding paths, spiraling paths, or any combination thereof. During an electrical fault, the electrical current may flow through the neutral electrode 290 to the fluid 362 held inside the HRG tank 354. The fluid 362 inside the HRG tank 354 may direct the electrical current through the fluid 362 along the resistor fluid path 330 towards one or more ground conductors 358. In the illustrated embodiment, the electrical current flows in opposite directions from the neutral conductors 290 through the fluid 362 along the resistor fluid paths 330A and 330B to the ground conductors 358 at the opposite ends 336 (e.g., 336A and 336B). Again, the insulators 356 force the electrical currently to flow along the entire resistor fluid path 330 (e.g., 330A and 330B) before reaching the ground conductors 358. As the current flows through the fluid 362 resistor fluid path 330 towards the ground conductor 358, the fluid 362 may heat up as the energy from the electrical current dissipates into the fluid 362.

To extend the distance the current must travel through the fluid 362 to reach ground conductors 358, the inside of the HRG tank 354 may be partially lined with the insulators 356 to define a geometry (e.g., length, width, cross-sectional area, and shape or pattern along the longitudinal axis 332) of the resistor fluid path 330. The insulators 356 may be any electrically nonconductive insulation material (e.g., plastic, rubber, Fluoropolymer, etc.). Indeed, the insulators 356 may be strategically placed around the HRG tank 354 to prevent the electrical current from moving from the one or more neutral electrodes 290 to the one or more ground conductor 358 without covering adequate distance along the resistor fluid path 330 to dissipate the desired amount of energy. In some embodiment, the insulators 356 include one or more coatings or layers of insulation material (e.g., spray coatings, dipped coatings, etc.), inserts of insulation material (e.g., panels or sheets), or any combination thereof, disposed along the HRG tank walls 360. The size and number of insulators 356 may be based on the amount of energy expected to flow through the resistor system 350. For example, if a higher amount of energy is anticipated in the resistor system 350, the HRG system 220 may extend the resistor fluid path 330 defined by the insulators 356 over a greater distance, with multiple turns, and/or over a greater volume within the HRG tank 354 (e.g., greater than 50, 60, 70, 80, or 90 percent of the volume). By further example, if a lower amount of energy is anticipated in the resistor system 350, the HRG system 220 may extend the resistor fluid path 330 defined by the insulators 356 over a lesser distance, with lesser or no turns, and/or over a lesser volume within the HRG tank 354 (e.g., less than 10, 20, 30, or 40 percent of the volume).

In some embodiments, the insulators 356 may only cover some or all of the HRG tank walls 360. To increase the distance the electric current travels from the neutral electrode 290 to reach ground conductor 358, the HRG tank walls 360 may be covered on the inside with insulators 356. The insulators 356 may prevent the electric current from reaching ground conductor 358 preemptively (e.g., before a desired amount of energy has dissipated from the electric current). The placement of the insulators 356 may be based on factors such as the amount of anticipated energy in the electric current, the heat capacity of the fluid 362, the location of the one or more sections of ground conductor 358 in the HRG tank 354, the location of the one or more neutral electrodes 290 in the HRG tank 354, the shape of the HRG tank 354, and the like. In embodiments where the neutral electrode 290 is on the far side of the tank from where the electrical current needs to reach, such as rectangular tanks 5354, all walls but one may be covered with the insulator 356, which may direct the electric current from the neutral electrode 290 through the resistor fluid path 330 to the far side of the HRG tank 354 to reach ground, heating up the fluid 362 and dissipating the energy in the electric current along the way.

Conversely, in other embodiments, the insulators 356 may cover none of the HRG tank walls 360 and/or the insulators 356 may be offset away from the HRG tank walls 360. This insulator pattern may function most effectively in the embodiment described directly below. However, in an embodiment with a wide-radius spherical or cylindrical tank and the neutral electrode 290 in the center of the tank, it may be unnecessarily costly to insulate part of the inside of the HRG tank 354 if the expected energy is anticipated to dissipate in the fluid before it reaches the HRG tank walls 360 regardless.

In some embodiments, the insulators 356 may create a winding passage pattern of the resistor fluid path 330 between the neutral electrode 290 and the one or more ground conductors 358. In embodiments where the HRG tank 354 is a smaller size but the distance to dissipate the expected energy to the desired amount is higher, the distance between the one or more neutral electrodes 290 and the desired electrical area to the ground conductors 358 may be increased by adding insulators 356 within the HRG tank 354. These insulators 356 may force the electrical current to divert around the insulators 356 to arrive at the ground conductors 358, which may increase the distance the electrical current travels. The insulators 356 may form a winding-path, labyrinth, maze, spiral, or other design to increase the distance the electrical current must pass through on its path to the desired ground conductor 358. Some of these potential designs may be discussed in reference to the other figures below. However, there may be infinite potential designs based on the user's goals, and the inclusion of discussion surrounding the following designs should in no way be construed to limit this disclosure to only the designs included in the figures.

The ground conductor 358 may be any piece of electrically conductive material suitable for carrying the electrical current to the earth. The ground conductor 358 may be designed based on the electrical current received by the neutral electrode 290 and the amount of energy dissipated by the electrical current's progression through the fluid 362. In some embodiments, the ground conductor 358 may include at least a portion of the HRG tank 354 (e.g., HRG tank walls 360), a metal rod, block, wire, or any other suitable electrically conductive structure. The ground conductor 358 may be included in the HRG tank 354 at any suitable distance from the neutral electrode 290 based on the goals, desired operating parameters, the heat capacity of the fluid 362, and the like.

In some embodiments, the HRG tank walls 360 may be grounded, and are grounded through connection to an umbilical termination head (not shown), and up to the vessel or surface facility, such as platform 112 shown in FIG. 1. The neutral electrode 290 may be sufficiently separated from the HRG tank walls 360 by the insulators 356 and the fluid 362. As such, the electrical current may seek out the HRG tank walls 360 during a ground fault scenario. In this embodiment, the neutral electrode 290 may be separated from the HRG tank walls 360 by insulators 356 on the HRG tank walls 360, insulators 356 offset from the HRG tank walls 360, in a variety of geometries of the resistor fluid path 330 (e.g., straight or non-straight, curved, winding, spiraling, etc.), or any combination thereof.

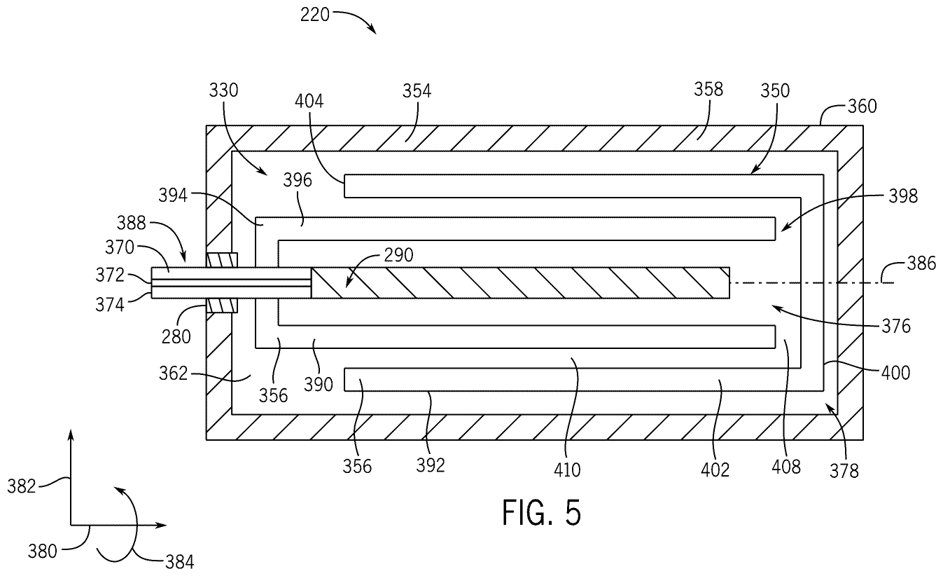

In some embodiments, the neutral electrode 290 may be connected to a penetrator in the HRG tank 354, similar to the penetrator 370 of FIG. 5. The penetrator may connect the electrical system to the earth through the resistor system 350. Indeed, the penetrator may penetrate the HRG tank 354 and limit the ground fault current to a low level. Further, the penetrator may be located inside a bushing 280 in the HRG tank wall 360. The bushing 280 may connect the penetrator and/or neutral electrode 290 to the HRG system 220.

The HRG tank 354 may be filled with fluid 362 in the resistor system 350 and the cooler pipes 352. The fluid 362 may be any conductive fluid, including but not limited to water, water-based fluids, waterless fluids, cooling fluids or coolants, nanofluids (e.g., carrier fluid with nanoparticles), additives, or any combination thereof. In certain embodiments, the water includes freshwater, purified water, deionized water, or any combination thereof. In some embodiments, the fluid 362 excludes saltwater and the HRG tank 354 isolates the fluid 362 from saltwater in the subsea environment. In some embodiments, the additives include corrosion inhibitors and antifreeze. The antifreeze may include a glycol (e.g., ethylene glycol, diethylene glycol, propylene glycol, or any combination thereof) and the fluid 362 may include a water-glycol mixture as a coolant or cooling fluid. The fluid 362 is disposed along the resistor fluid path 330 between the conductors (e.g., the neutral conductor 290 and the ground conductor 358). In certain embodiments, the fluid 362 is a cooling fluid (e.g., antifreeze, water-glycol mixture,, etc.), having a relatively higher heat capacity than water alone. However, freshwater is also an acceptable fluid 362. Freshwater has superior heat capacity, and a small volume of water may withstand a large amount of power without overheating before disconnection. Fluids 362 with higher heat capacities may have a greater capacity to absorb and dissipate energy from an electrical current flowing through the fluid 362. In high voltage (e.g., greater than or equal to 6 kV) scenarios suitable for the disclosed HRG tank 354, the connection may last only 0.5 seconds. However, the connection may last 1 second, 1.5 seconds, 2 seconds, 2.5 seconds, or up to 3 seconds. Due to the short duration of the connection, fluids 362 with large heat capacities may withstand the high voltage connection.

The HRG system 220 may also include cooler pipes 352 (e.g., fluid cooling section). The cooler pipes 352 may include a plurality of cooling tubes 338 extending lengthwise between opposite chambers 340 (e.g., 340A and 340B), wherein each of the plurality of cooling tubes 338 includes a cooling flow path 342 defined by a tube wall 344. In the illustrated embodiment, each of the plurality of cooling tubes 338 extends along a longitudinal axis 346 between the opposite chambers 340 (e.g., 340A and 340B), wherein the longitudinal axes 346 of the plurality of cooling tubes 338 are straight and parallel to one another. However, in some embodiments, the longitudinal axes 346 of the plurality of cooling tubes 338 are non-straight (e.g., curved, winding, spiraling, etc.) and/or non-parallel to one another. The number and geometry (e.g., length, width, cross-sectional area, volume, shape, etc.) of the plurality of cooling tubes 338 may be selected based on a needed cooling capacity for cooling the fluid 362. The plurality of cooling tubes 338 may be externally exposed to the surrounding seawater, which transfers heat away from the fluid 362 into the seawater to cool the fluid 362. In certain embodiments, the heat generated during a fault event may cause a thermally-induced fluid flow of the fluid 362 from the resistor fluid path 330 of the resistor system 350 to the cooling flow paths 342 in the cooler pipes 352 for cooling of the fluid 362, followed by a return flow back to the resistor fluid path 330. In some embodiments, the HRG system 220 may include one or more pumps to drive a fluid flow of the fluid 362 between the resistor system 350 and the cooler pipes 352.

In operation, the cooler pipes 352 are configured to cool the fluid 362 after the fluid 362 transports the electric current from the one or more neutral electrodes 290 to the ground conductor 358. The degree to which the fluid 362 may heat up may be based on the fluid's heat capacity, the fluid's starting temperature, the amount of energy the electric current provided to the fluid 362, and the like. For example, a fluid 362 with a high heat capacity and a smaller electric current may cool down faster than a fluid 362 with a small heat capacity and a larger electric current, as the latter fluid's 362 temperature may have increased more as it carried the electric current. Therefore, the latter fluid 362 may use a longer flow path to return to its original temperature. To accommodate the need for cooling, the cooler pipes 352 may be longer, or there may be more cooling pipes 352. In some embodiments, the HRG system 220 may not have cooling pipes 352. Instead, the HRG tank 354 may incorporate enough spare space to naturally cool the fluid 362 without cooler pipes 352.

FIG. 5 is a schematic diagram of an embodiment of the HRG system 220 of FIGS. 1-4, further illustrating an embodiment of the resistor system 350 within the HRG tank 354. Various elements and functions of the illustrated embodiment are substantially the same or similar to the embodiment described above with reference to FIG. 4. Accordingly, like numbers are used to describe like elements in the illustrated embodiment, and the description of these numbered elements applies to each embodiment described herein. In the illustrated embodiment, the HRG system 220 includes the HRG tank 354 having the HRG tank walls 360, a penetrator 370, a fluid 362, insulators 356, a neutral conductor 290, and a ground conductor 358. The penetrator 370 extends through an opening in the HRG tank wall 360 and connects with the neutral conductor 290 within the HRG tank 354. The penetrator 370 is supported by the bushing 280 disposed in the opening in the HRG tank wall 360. The penetrator 370 includes a conductor 372 surrounded by an outer insulation 374. The conductor 372 connects to the neutral conductor 290 to direct the electrical current from the penetrator 370 to the neutral conductor 290. From the neutral conductor 290, the electrical current may flow through the fluid 362 along a resistor fluid path 330 to the ground conductor 358 (e.g., the HRG tank wall 360).

In the illustrated embodiment, the resistor fluid path 330 has a winding fluid path 376 defined by a nested arrangement 378 of the insulators 356. For purposes of discussion, reference may be made to an axial direction or axis 380, a radial direction or axis 382, and a circumferential direction or axis 384 relative to a longitudinal axis 386 of the HRG system 220. For example, the penetrator 370 and the neutral conductor 290 define a central axial member 388 extending in the axial direction 380 along the longitudinal axis 386. The insulators 356 include cup-shaped insulators 390 and 392 disposed circumferentially 384 about the central axial member 388. For example, the cup-shaped insulator 390 has a base plate 394 coupled to a side wall 396 (e.g., outer sleeve), wherein the side wall 396 extends axially 380 from the base plate 394 to a distal axial end 398. As illustrated, the base plate 394 is coupled to the outer insulation 374 of the penetrator 370 and the side wall 396 extends circumferentially 380 about the neutral conductor 290 at a radial 382 offset distance away from the neutral conductor 290. By further example, the cup-shaped insulator 392 has a base plate 400 coupled to a side wall 402 (e.g., outer sleeve), wherein the side wall 402 extends axially 380 from the base plate 400 to a distal axial end 404. In the illustrated embodiment, the cup-shaped insulator 392 is disposed circumferentially 384 about the cup-shaped insulator 390 and the neutral conductor 290 in an axially opposite orientation relative to the cup-shaped insulator 390. As illustrated, the base plate 400 of the cup-shaped insulator 392 is disposed adjacent and axially offset from the distal axial end 398 of the cup-shaped insulator 390, while the base plate 394 of the cup-shaped insulator 390 is disposed adjacent and axially offset from the distal axial end 404 of the cup-shaped insulator 390. In certain embodiments, the cup-shaped insulators 390 and 392 are annular-shaped insulators, rectangular-shaped insulators, polygonal-shaped insulators, or any combination thereof. Additionally, the central axial member 388 (e.g., penetrator 370 and neutral conductor 290) and the cup-shaped insulators 390 and 392 may be coaxial or concentric with one another. As a result of this nested arrangement 378, the winding fluid path 376 of the resistor fluid path 330 has an axial fluid path 406 (e.g., annular fluid path) between the neutral conductor 290 and the cup-shaped insulator 390, a radial fluid path 408 (e.g., annular or disc-shaped fluid path) between the distal axial end 398 and the base plate 400, and an axial fluid path 410 (e.g., annular fluid path) between the cup-shaped insulator 390 and the cup-shaped insulator 392. Furthermore, the axial fluid path 406 is oriented in an opposite axial direction 380 relative to the axial fluid path 410. Upon reaching the distal axial end 404, the winding fluid path 376 of the resistor fluid path 330 reaches the ground conductor 358 defined by the HRG tank wall 360.

In operation, in the event of an electrical fault, the winding fluid path 376 of the resistor fluid path 330 increases the length and alternates directions to help increase the effectiveness of the HRG system 220 while dissipating energy. In the illustrated embodiment, the insulators 356 (e.g., cup-shaped insulators 390 and 392) form two U-shaped passageways, one within the other and facing in opposite directions. The insulators 356 may direct the electrical current from the neutral electrode 290 to the ground conductor 358. In the illustrated embodiment, the ground conductor 358 is the HRG tank walls 360. As such, the neutral electrode 290 may be in approximately the center or mid-point of the HRG tank 354, so that the electrical current may flow through a greater volume of fluid 362 before it arrives at the HRG tank walls 360. This may provide for more energy dissipating before the electrical current reaches the ground conductor 358. In certain embodiments, the resistor system 350 may include 1, 2, 3, 4, 5, 6, 7, 8, 9, 10, or more cup-shaped insulators 356 in the nested arrangement 378 similar to that shown with the cup-shaped insulators 390 and 392, such that the cup-shaped insulators are arranged in diametrically opposite orientations one about another to define the nested arrangement 378.

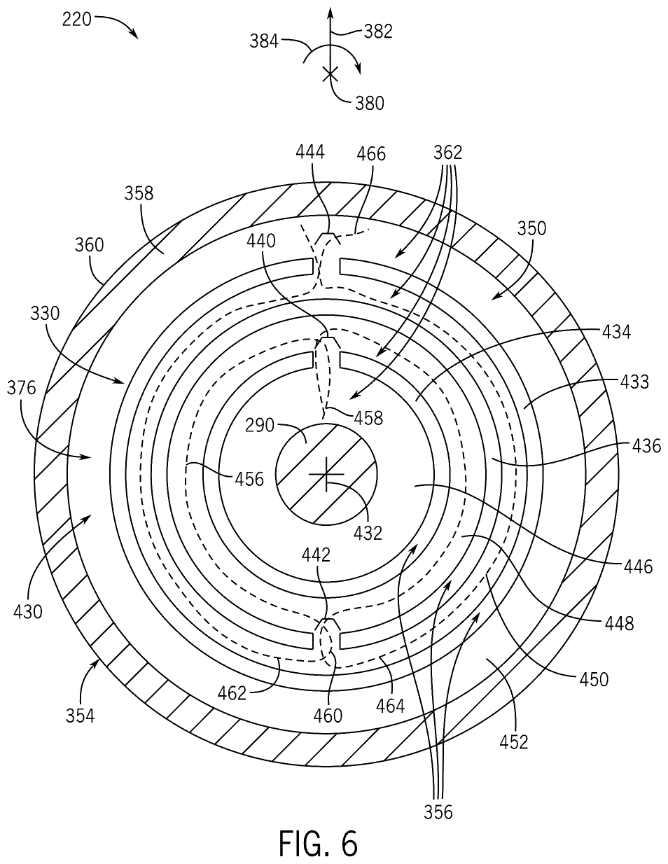

FIG. 6 is a schematic diagram of an embodiment of the HRG system 220 of FIGS. 1-4, further illustrating an embodiment of the resistor system 350 within the HRG tank 354. Various elements and functions of the illustrated embodiment are substantially the same or similar to the embodiment described above with reference to FIGS. 4 and 5. Accordingly, like numbers are used to describe like elements in the illustrated embodiment, and the description of these numbered elements applies to each embodiment described herein. In the illustrated embodiment, the resistor fluid path 330 has a winding fluid path 376 defined by a nested arrangement 430 (e.g., a labyrinth arrangement) of the insulators 356.

The nested arrangement 430 of the insulators 356 is disposed about the neutral conductor 290, which is disposed at a central position 432 (e.g., a central axis) of the HRG tank 354. The insulators 356 include annular insulators 434, 436, and 438 disposed in the nested arrangement 430 about the neutral conductor 290. For example, the annular insulators 434, 436, and 438 and the neutral conductor 290 may be coaxial with the central axis and/or concentric with one another. The annular insulators 434, 436, and 438 include one or more radial openings or fluid passages 440, 442, and 444, respectively, circumferentially offset from one another along the winding fluid path 376 from one insulator to another in the annular insulators 434, 436, and 438. Additionally, the HRG tank 354, the neutral conductor 290, and the insulators 356 (e.g., 434, 436, and 438) define a plurality of annular chambers 446, 448, 450, and 452 fluidly coupled together via the fluid passages 440, 442, and 444. For example, the annular insulator 434 is radially 382 offset about the neutral conductor 290 to define the annular chamber 446. The annular insulator 436 is radially 382 offset about the annular insulator 434 to define the annular chamber 448. The annular insulator 438 is radially 382 offset about the annular insulator 436 to define the annular chamber 450. The HRG tank 354 (e.g., annular tank) is radially 382 offset about the annular insulator 438 to define the annular chamber 452. The nested arrangement 430 may include any number of annular insulators and annular chambers. In some embodiments, the HRG tank 354 and the insulators 356 (e.g., 434, 436, and 438) may include a variety of shapes (e.g., annular, spherical, square, polygonal, hexagonal, etc.) in a similar nested arrangement.

Regardless of the shape and number of insulators 356, the winding fluid path 376 of the resistor fluid path 330 includes a plurality of circumferential fluid paths and radial fluid paths between the neutral conductor 290 and the ground conductor 358 formed by the HRG tank wall 360. As illustrated, the winding fluid path 376 includes a radial fluid path 454 from the annular chamber 446 through the fluid passage 440, a pair of opposite circumferential fluid paths 456 and 458 through the annular chamber 448 from the fluid passage 440 to the fluid passage 442, a radial fluid path 460 from the annular chamber 448 through the fluid passage 442, a pair of opposite circumferential fluid paths 462 and 464 through the annular chamber 450 from the fluid passage 442 to the fluid passage 444, and a radial fluid path 466 from the annular chamber 450 through the fluid passage 444 to the annular chamber 452. In the illustrated embodiments, the fluid passages 440, 442, and 444 are circumferentially 384 staggered relative to one another. For example, the fluid passages 440 and 442 are circumferentially 384 offset by about 180 degrees, while the fluid passages 442 and 444 are circumferentially 384 offset by about 180 degrees. Thus, the nested arrangement 430 increases a length and complexity of the winding fluid path 376.

In operation, in the event of an electrical fault, the electrical current may emerge from the neutral electrode 290 at the center of the nested arrangement 430 of insulators 356. The neutral electrode 290 may be connected to a penetrator as described in previous embodiments. As such, the electrical current may flow through the fluid 362 along the winding fluid path 376 described above. The electrical current may take one or more of the winding passages to reach ground conductor 358. The winding passage may be of adequate length to dissipate the desired amount of energy before the electrical current reaches ground conductor 358.

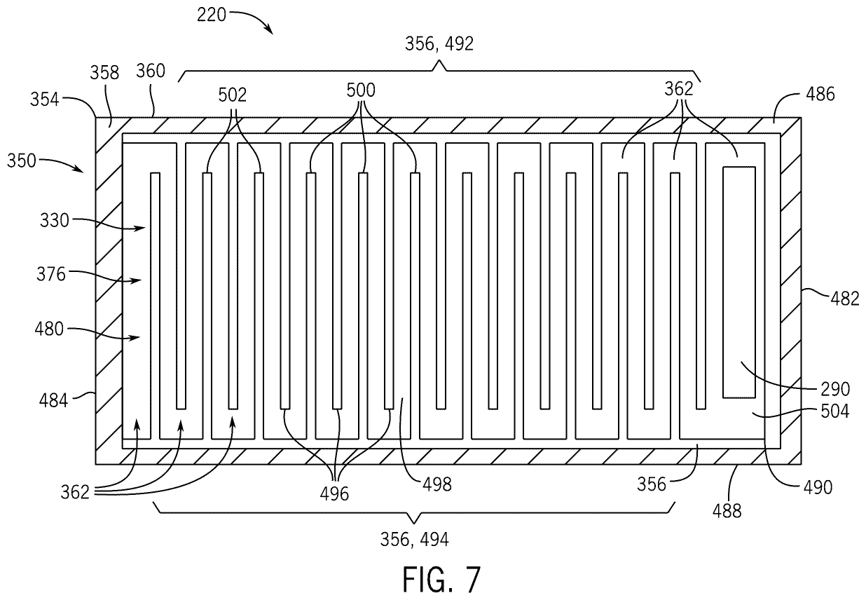

FIG. 7 is a schematic diagram of an embodiment of the HRG system 220 of FIGS. 1-4, further illustrating an embodiment of the resistor system 350 within the HRG tank 354. Various elements and functions of the illustrated embodiment are substantially the same or similar to the embodiment described above with reference to FIGS. 4-6. Accordingly, like numbers are used to describe like elements in the illustrated embodiment, and the description of these numbered elements applies to each embodiment described herein. In the illustrated embodiment, the resistor fluid path 330 has a winding fluid path 376 defined by a staggered arrangement 480 of the insulators 356.

In the illustrated embodiment, the HRG system 220 include an HRG tank 354 surrounding the staggered arrangement 480 of the insulators 356, wherein the HRG tank wall 360 includes opposite end walls 482 and 484 and opposite side walls 486 and 488. The opposite side walls 486 and 488 extend between and connect with the opposite end walls 482 and 484. In the illustrated embodiment, the neutral conductor 290 is disposed adjacent (but offset from) the end wall 482, whereas the ground conductor 358 is disposed at (or formed as) the end wall 484. The insulators 356 include an insulator 490 (e.g., insulation layer, coating, or panel) along the interior surface of the HRG tank wall 360 at the end wall 482 and the side walls 486 and 488, but not at the end wall 484. The insulators 356 further include a set of projecting insulators 492 (e.g., fins, walls, plates, etc.) coupled to the insulator 490 along the side wall 486, and a set of projecting insulators 494 (e.g., fins, walls, plates, etc.) coupled to the insulator 490 along the side wall 488. In the illustrated embodiment, the set of projecting insulators 492 is staggered relative to the set of projecting insulators 494, such that each one of the projecting insulators 492 is disposed between a pair of adjacent projecting insulators 494, and each one of the projecting insulators 494 is disposed between a pair of adjacent projecting insulators 492. Additionally, the projecting insulators 492 and 494 are generally parallel with one another and parallel with the end walls 482 and 484, although other embodiments may configure the projecting insulators 492 and 494 at acute angles, flat shapes, curved, shapes, or any combination thereof. As further illustrated, each of the projecting insulators 492 extends less than a full distance (e.g., approximately 70 to 95 percent) from the side wall 486 toward the side wall 488 to leave a gap or fluid passage 496 between a tip 498 of the projecting insulators 492 and the side wall 488. Likewise, each of the projecting insulators 494 extends less than a full distance (e.g., approximately 70 to 95 percent) from the side wall 488 toward the side wall 486 to leave a gap or fluid passage 500 between a tip 502 of the projecting insulators 492 and the side wall 488. As a result, the winding fluid path 376 extends back and forth between the opposite side walls 486 and 488 between the adjacent projecting insulators 492 and 494 from the neutral conductor 290 at the end wall 482 to the ground conductor 358 at the end wall 484. As illustrated, the neutral conductor 290 is spaced apart from the insulators 356 (e.g., 490, 492, and 494) in a chamber 504 near the end wall 482.

The HRG tank 354, the HRG tank walls 360, the insulators 356, and the winding fluid path 376 may have a variety of shapes and configurations based on the illustrated embodiment. The HRG tank 354 may be annular, rectangular, or other shapes. The end walls 482 and 484 may be flat or curved (e.g., dome-shaped), and the side walls 486 and 488 may be flat or curved (e.g., annular). Likewise, the insulators 492 and 494 may be flat or curved, and the neutral conductor 290 may be flat or curved.

In the illustrated embodiment, the electrical current may flow from the neutral electrode 290 into the fluid 362. The neutral electrode 290 may be connected to the transformer 140 via a conducting penetrator, which may direct the electrical current from the transformer 140 to the neutral electrode 290. Once in the fluid 362, the electrical current may flow through the fluid 362 along the winding fluid path 376 between the insulators 356 before arriving at ground conductor 358 on the opposite side of the HRG tank 354. In the illustrated embodiment, the HRG tank wall 360 acts as ground conductor 358 for the resistor system 350. However, in other embodiments, the ground conductor 358 may be any suitable conductor, such as a pipe, wire, strip of metal, or the like.

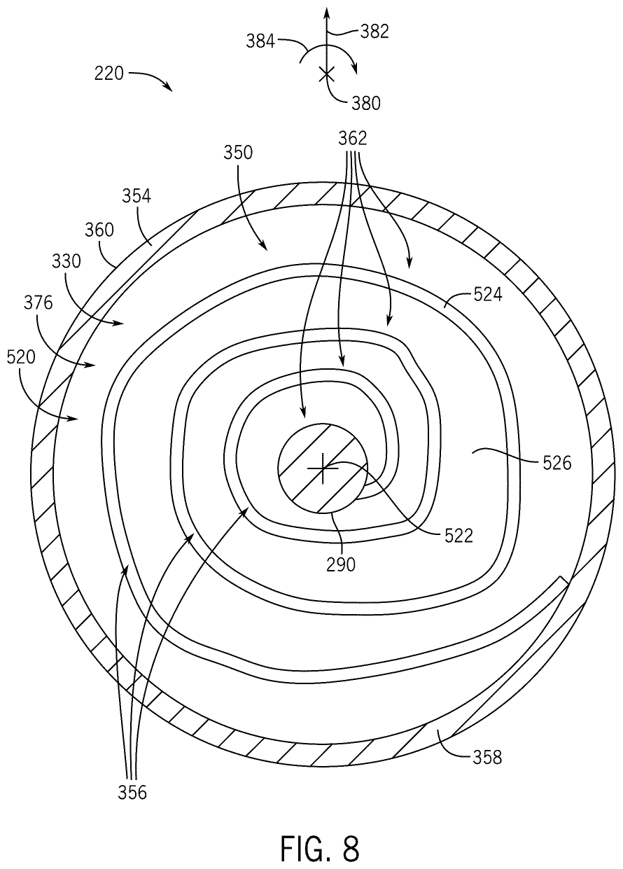

FIG. 8 is a schematic diagram of an embodiment of the HRG system 220 of FIGS. 1-4, further illustrating an embodiment of the resistor system 350 within the HRG tank 354. Various elements and functions of the illustrated embodiment are substantially the same or similar to the embodiment described above with reference to FIGS. 4-7. Accordingly, like numbers are used to describe like elements in the illustrated embodiment, and the description of these numbered elements applies to each embodiment described herein. In the illustrated embodiment, the resistor fluid path 330 has a winding fluid path 376 defined by a spiral arrangement 520 of the insulators 356. In particular, the neutral conductor 290 may be disposed at a central position 522 (e.g., central axis) of the HRG tank 354, and the insulator 356 includes a spiraling insulator 524 (e.g., spiraling insulator wall) coupled to the neutral conductor 290 and the HRG tank wall 360. Thus, the spiraling insulator 524 spirals outwardly away from the neutral conductor 290 in both the circumferential direction 384 and the radial direction 382, thereby defining the winding fluid path 376 as a spiraling fluid path 526 (e.g., spiral fluid path, helical fluid path, or the like). Similar to previous embodiments, the ground conductor 358 may be coupled to and/or defined by the HRG tank wall 360.

In the illustrated embodiment, the HRG tank 354 of the HRG system 220 is a cylinder or sphere. However, in other embodiments, the HRG tank 354 may be a square, rectangle, triangle, or other shape. In embodiments where the HRG tank 354 is not a sphere or cylinder, the spiral-type insulators may still spiral as the insulators do in the illustrated embodiment (e.g., with substantially smooth curves) or the insulators may have sharp corners of greater than or equal to 45 degrees, greater than or equal to 60 degrees, greater than or equal to 75 degrees, or equal to 90 degrees.

In the illustrated embodiment, the electrical current may emerge from the neutral electrode 290 at the center of the spiraling fluid path 526. The neutral electrode 290 may be connected to a penetrator as described in previous embodiments. As such, the electrical current may flow through the fluid 362 along the spiraling fluid path 526 defined by the spiraling insulator 524. The spiraling fluid path 526 may be of adequate length to dissipate the desired amount of energy before the electrical current reaches ground conductor 358.

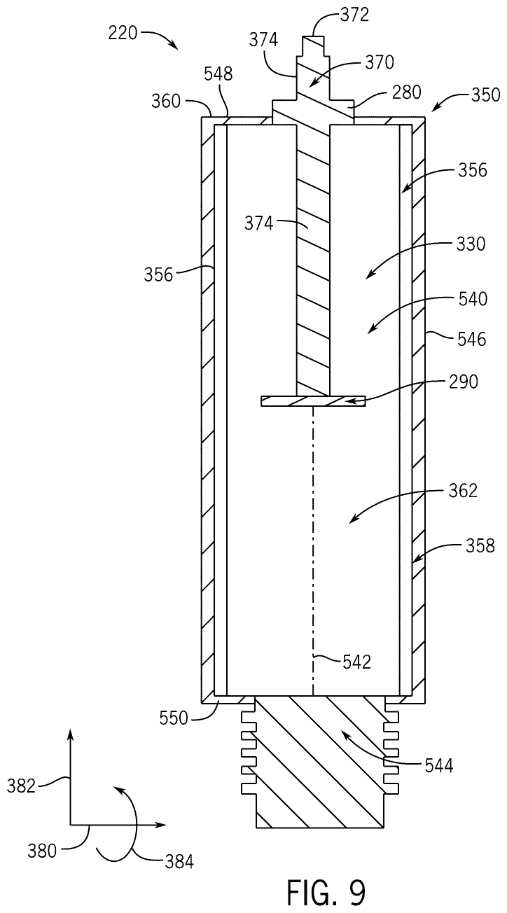

FIG. 9 is a schematic diagram of an embodiment of the HRG system 220 of FIGS. 1-4, further illustrating an embodiment of the resistor system 350 within the HRG tank 354. Various elements and functions of the illustrated embodiment are substantially the same or similar to the embodiment described above with reference to FIGS. 4-8. Accordingly, like numbers are used to describe like elements in the illustrated embodiment, and the description of these numbered elements applies to each embodiment described herein. In the illustrated embodiment, the resistor fluid path 330 has a straight fluid path 540 in the axial direction 380 along a central axis 542 of the HRG tank 354. Additionally, in the illustrated embodiment, a pressure compensator 544 is coupled to the HRG tank 354.

In the illustrated embodiment, the HRG system 220 includes the HRG tank 354 having the resistor system 350. A penetrator 370 may direct any electrical current into the HRG tank 354 at the neutral conductor 290. Similar to FIG. 5, the penetrator 370 may include the bushing 280 at the HRG tank wall 360, the conductor 372 to carry the electrical current to the neutral electrode 290, and the outer insulation 374 disposed about the conductor 372. In some embodiments, the bushing 280 may form part of the outer insulation 374. In the illustrated embodiment, the penetrator 370 extends axially 380 into the HRG tank 354 to approximately the mid-way point of the HRG tank 354, and couples to the neutral conductor 290 at the mid-way point. In some embodiments, the neutral electrode 290 may be closer to the top or bottom of the HRG tank, based on the location of the insulators 356, the type of fluid 362, the expected electrical current, and the goals of the HRG system 220. Fluid 362 may fill the HRG tank 354, and the HRG tank walls 360 may be substantially lined with insulators 356 (e.g., inner insulation layer). The insulators 356 may block the electrical current from preemptively reaching ground conductor 358, which may be the HRG tank walls 360 or a separate piece of conductor. In the illustrated embodiment, ground conductor 358 is the HRG tank walls 360. As such, in the illustrated embodiment, the insulators 356 cover the HRG tank walls 360 along an entire axial length of the HRG tank walls 360 along a side wall 546 between oppose axial end walls 548 and 550, while not covering the axial end walls 548 and 550. However, in some embodiments, the insulators 356 may cover portions of the end walls 548 and 550 and/or less than the entire axial length of the side wall 546. The penetrator 370 couples to the end wall 548, whereas the pressure compensator 544 couples to the end wall 550. In some embodiments, the pressure compensator 544 may be coupled to any one or more HRG tank walls 360 of the HRG tank 354 of FIGS. 4-9.

In the illustrated embodiment, the electrical current may flow into the HRG tank 354 via the penetrator 370. The penetrator 370 may send the electrical current through the bushing 280 and the outer insulation 374 via the conductor 372 to the neutral electrode 290. In turn, the electrical current may flow out of the neutral electrode 290 through the fluid 362 along the straight fluid path 540 to the ground conductor 358. In the illustrated embodiment, ground conductor 358 is the HRG tank wall 360 at the end walls 548 and 550 of the HRG tank 354. However, in some embodiments, ground conductor 358 may be a suitable conductor connected to the HRG tank 354 at a suitable distance from the neutral electrode 290 based on the type of fluid 362, the expected electrical current, the desired energy to dissipate between the neutral electrode 290 and ground conductor 358.

Further, the illustrated embodiment features the pressure compensator 544 coupled to the HRG tank 354 in fluid communication with the fluid 362. The pressure compensator 544 may account for pressure changes in the HRG tank 354 during a fault event. Specifically, any excess pressure changes that occur during a fault event may be absorbed by the pressure compensator 544 to protect the HRG tank 354. As noted above, the pressure compensator 544 may be coupled to the HRG tank 354 in any of the embodiments described herein. In certain embodiments, the pressure compensator 544 may include one or more of a bellows, a piston-cylinder assembly, a bladder, or any combination thereof.

Technical effects of the embodiments disclosed herein include a fluid-based HRG system having a resistor system (e.g., fluid resistor section) using a fluid as a resistor fluid path between a neutral conductor and a ground conductor. The resistor fluid path is capable of handling a large amount of energy and heat dissipation during an electrical fault. The resistor fluid path may include a variety of geometries, such as straight fluid paths, curved fluid paths, winding fluid paths, etc. Thus, the resistor fluid path may enable a desired length using the various geometries. The HRG system also may including a cooling system and/or a pressure compensator.

The subject matter described in detail above may be defined by one or more clauses, as set forth below.

A system includes a high resistance grounding system. The high resistance grounding system includes a subsea transformer tank. The high resistance grounding system further includes a subsea high resistance grounding system tank defined by a tank wall. Additionally, the high resistance grounding system includes a plurality of conductors and a plurality of insulators. The high resistance grounding system includes a fluid disposed between the plurality of conductors and between the plurality of insulators.

The system of the preceding clause, wherein the tank wall includes at least one conductor of the plurality of conductors.

The system of any preceding clause, wherein the plurality of conductors and plurality of insulators are interleaved.

The system of any preceding clause, wherein the plurality of conductors and plurality of insulators include a geometrical configuration that provides a labyrinth-like passage for a current to travel along.

The system of any preceding clause, wherein the labyrinth-like passage extends axially, radially, or both axially and radially.

A system includes a subsea transformer disposed in a subsea transformer tank, and a subsea high resistance grounding (HRG) system coupled to the subsea transformer. The subsea HRG system includes a subsea high resistance grounding (HRG) tank, a first conductor, a second conductor, and a resistor fluid path in the subsea HRG tank between the first and second conductors. The subsea HRG system also includes one or more insulators in the subsea HRG tank defining the resistor fluid path between the first and second conductors.

The system of the preceding clause, wherein the first conductor includes a neutral conductor, the second conductor includes a ground conductor, and at one of the first or second conductors is coupled to or formed by at least one tank wall of the subsea HRG tank.

The system of any preceding clause, wherein the resistor fluid path is a straight fluid path between the first and second conductors.

The system of any preceding clause, wherein the resistor fluid path includes a non-straight fluid path between the first and second conductors.

The system of any preceding clause, wherein the resistor fluid path includes a winding fluid path between the first and second conductors.

The system of any preceding clause, wherein the winding fluid path includes a spiral fluid path.

The system of any preceding clause, wherein the winding fluid path is defined by a nested arrangement of a plurality of the insulators.

The system of any preceding clause, wherein the winding fluid path extends back and forth in opposite axial directions, opposite circumferential directions, or a combination thereof, relative to a longitudinal axis of the nested arrangement.

The system of any preceding clause, wherein the plurality of insulators includes a plurality of cup-shaped insulators arranged in diametrically opposite orientations one about another to define the nested arrangement.

The system of any preceding clause, wherein the plurality of insulators includes a plurality of annular insulators arranged about another to define the nested arrangement, each of the plurality of annular insulators includes a radial opening, and the radial openings are circumferentially offset from one another along the winding fluid path from one insulator to another in the plurality of annular insulators.

The system of any preceding clause, wherein the winding fluid path is defined by a staggered arrangement of a first set projecting insulators coupled to a first wall and a second set projecting insulators coupled to a second wall.

The system of any preceding clause, including a cooling system coupled to the resistor fluid path.

The system of any preceding clause, including a pressure compensator coupled to the subsea HRG tank.

The system of any preceding clause, including a fluid disposed along the resistor fluid path, wherein the fluid includes a freshwater, a cooling fluid, or a combination thereof.

A method includes operating a subsea transformer disposed in a subsea transformer tank, and grounding the subsea transformer via a resistor fluid path of a subsea high resistance grounding (HRG) system coupled to the subsea transformer. The subsea HRG system includes a subsea high resistance grounding (HRG) tank, a first conductor, a second conductor, and the resistor fluid path in the subsea HRG tank between the first and second conductors. The subsea HRG system also includes one or more insulators in the subsea HRG tank defining the resistor fluid path between the first and second conductors.

The method of the preceding clause, wherein the resistor fluid path is a straight fluid path or a winding fluid path between the first and second conductors.

The method of any preceding clause, including a fluid disposed along the resistor fluid path, wherein the fluid includes a freshwater, a cooling fluid, or a combination thereof.

A system includes a high resistance grounding (HRG) system. The HRG system includes a high resistance grounding (HRG) tank, a first conductor, a second conductor, and a resistor fluid path in the HRG tank between the first and second conductors. The HRG system also includes one or more insulators in the HRG tank defining the resistor fluid path between the first and second conductors.

The system of the preceding clause, including a transformer coupled to the HRG system.

The system of any preceding clause, including a fluid disposed along the resistor fluid path, wherein the fluid includes a freshwater, a cooling fluid, or a combination thereof.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a subsea transformer disposed in a subsea transformer tank; and
a subsea high resistance grounding (HRG) system coupled to the subsea transformer, wherein the subsea HRG system comprises:
a subsea high resistance grounding (HRG) tank;
a first conductor;
a second conductor;
a resistor fluid path in the subsea HRG tank between the first and second conductors; and
one or more insulators in the subsea HRG tank defining the resistor fluid path between the first and second conductors.

2. The system of claim 1, wherein the first conductor comprises a neutral conductor, the second conductor comprises a ground conductor, and at one of the first or second conductors is coupled to or formed by at least one tank wall of the subsea HRG tank.

3. The system of claim 1, wherein the resistor fluid path is a straight fluid path between the first and second conductors.

4. The system of claim 1, wherein the resistor fluid path comprises a non-straight fluid path between the first and second conductors.

5. The system of claim 1, wherein the resistor fluid path comprises a winding fluid path between the first and second conductors.

6. The system of claim 5, wherein the winding fluid path comprises a spiral fluid path.

7. The system of claim 5, wherein the winding fluid path is defined by a nested arrangement of a plurality of the insulators.

8. The system of claim 7, wherein the winding fluid path extends back and forth in opposite axial directions, opposite circumferential directions, or a combination thereof, relative to a longitudinal axis of the nested arrangement.

9. The system of claim 7, wherein the plurality of insulators comprises a plurality of cup-shaped insulators arranged in diametrically opposite orientations one about another to define the nested arrangement.

10. The system of claim 7, wherein the plurality of insulators comprises a plurality of annular insulators arranged about another to define the nested arrangement, each of the plurality of annular insulators comprises a radial opening, and the radial openings are circumferentially offset from one another along the winding fluid path from one insulator to another in the plurality of annular insulators.

11. The system of claim 5, wherein the winding fluid path is defined by a staggered arrangement of a first set projecting insulators coupled to a first wall and a second set projecting insulators coupled to a second wall.

12. The system of claim 1, comprising a cooling system coupled to the resistor fluid path.

13. The system of claim 1, comprising a pressure compensator coupled to the subsea HRG tank.

14. The system of claim 1, comprising a fluid disposed along the resistor fluid path, wherein the fluid comprises a freshwater, a cooling fluid, or a combination thereof.

15. A method, comprising:
operating a subsea transformer disposed in a subsea transformer tank; and
grounding the subsea transformer via a resistor fluid path of a subsea high resistance grounding (HRG) system coupled to the subsea transformer, wherein the subsea HRG system comprises:
a subsea high resistance grounding (HRG) tank;
a first conductor;
a second conductor;
the resistor fluid path in the subsea HRG tank between the first and second conductors; and
one or more insulators in the subsea HRG tank defining the resistor fluid path between the first and second conductors.

16. The method of claim 15, wherein the resistor fluid path is a straight fluid path or a winding fluid path between the first and second conductors.

17. The method of claim 15, comprising a fluid disposed along the resistor fluid path, wherein the fluid comprises a freshwater, a cooling fluid, or a combination thereof.

18. A system, comprising:
a high resistance grounding (HRG) system, comprising:
a high resistance grounding (HRG) tank;
a first conductor;
a second conductor;
a resistor fluid path in the HRG tank between the first and second conductors; and
one or more insulators in the HRG tank defining the resistor fluid path between the first and second conductors.

19. The system of claim 18, comprising a transformer coupled to the HRG system.

20. The system of claim 18, comprising a fluid disposed along the resistor fluid path, wherein the fluid comprises a freshwater, a cooling fluid, or a combination thereof.
